(19) United States
(12) Patent Application Publication
(10) Pub. No.: US 2021/0156484 A1
(43) Pub. Date: May 27, 2021

(54) INTEGRATED PISTON-SEAL STRUCTURE FOR VEHICLE ELECTRONIC COMPRESSOR BYPASS VALVE

(71) Applicant: Vitesco Technologies USA, LLC, Auburn Hills, MI (US)

(72) Inventor: Ravinder Singh Gill, Chatham (CA)

(21) Appl. No.: 16/693,789

(22) Filed: Nov. 25, 2019

(51) Int. Cl. F16K 1/46; F16K 1/42; F02B 37/16

(52) U.S. Cl. CPC F16K 1/46; F02B 37/162; F16K 1/42

(57) ABSTRACT

An electronic compressor bypass valve (eCBV) includes a housing having an annular internal surface defining an opening therein. A piston-seal structure is constructed and arranged to be movable linearly within the opening. The piston-seal structure includes a generally cylindrical piston portion having proximal and distal ends. The distal end defines a seal surface constructed and arranged to seal with a body. The proximal end defines a first outer diameter. The piston-seal structure further includes an annular seal portion fixed to the proximal end of the piston portion. The seal portion has an outer diameter that is larger than the first outer diameter of the piston portion, thereby defining an annular sealing surface. Upon movement of the piston-seal structure, the sealing surface is constructed and arranged to slidingly engage the annular internal surface of the housing thereby creating an annular seal between the piston portion and the housing.

### FIELD

The invention relates to vehicle turbocharged internal combustion engines and, more particularly, to an electronic compressor bypass valve (eCBV) that has an integrated seal and piston structure.

### BACKGROUND

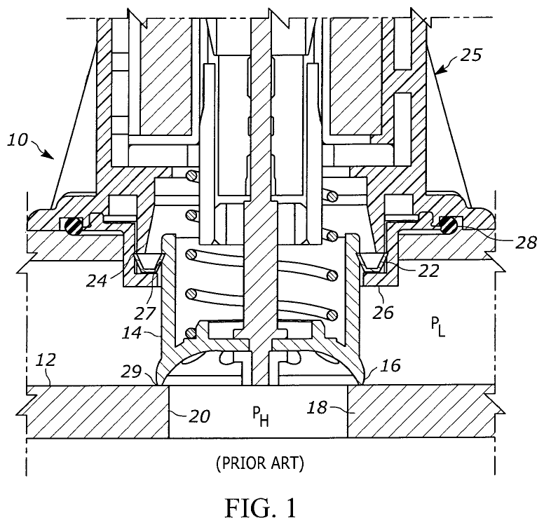

With reference to FIG. 1, a portion of a conventional electronic compressor bypass valve (eCBV) is shown, generally indicated at 10, disposed in a bypass line 12 of a turbocharger system of a vehicle between a high pressure side P_{H} and a low pressure side P_{L}, so as to prevent turbocharger surge and to reduce turbo lag. The eCBV 10 includes a piston 14 having a seal surface 16 that, in a closed position, engages with a body 18 to prevent the high pressure line 20 from communication with the lower pressure line 12. In addition, an internal seal 22, separate from the piston 14 provides a radial seal between the piston 14 and an over-mold housing 24 of the ECBV 10. This internal seal 22 is held in place by a ‘shield-pot’ 26. Using a shield-pot creates additional leakage path requiring additional sealing using an internal O-ring or by use of a laser weld, in addition to an already existing O-ring 28 to block off external leakage. The piston 14 is movable between opened and closed positions by a solenoid, generally indicated at 25, while the V-seal 22, shield pot 26 and O-ring 28 remain stationary. A pressure balance exists between contact areas 27 and 29.

Thus, there is a need to provide an eCBV that has an integrated piston-seal structure so as eliminate a leakage path and to reduce, parts, cost and assembly operations.

### SUMMARY

An objective of the invention is to fulfill the need referred to above. In accordance with the principles of a present embodiment, this objective is achieved by an electronic compressor bypass valve (eCBV) that includes a housing having an annular internal surface defining an opening therein. A piston-seal structure is constructed and arranged to be movable linearly within the opening. The piston-seal structure includes a generally cylindrical piston portion having proximal and distal ends. The distal end defines a seal surface constructed and arranged to seal with a body. The proximal end defines a first outer diameter. The piston-seal structure further includes an annular seal portion fixed to the proximal end of the piston portion. The seal portion has an outer diameter that is larger than the first outer diameter of the piston portion, thereby defining an annular sealing surface. Upon movement of the piston-seal structure, the sealing surface is constructed and arranged to slidingly engage the annular internal surface of the housing thereby creating an annular seal between the piston portion and the housing.

In accordance with another aspect of an embodiment a method of sealing a piston portion with respect to a housing of an electronic compressor bypass valve provides a generally cylindrical piston portion with proximal and distal ends. The distal end defining a seal surface constructed and arranged to seal with a body. An annular seal portion is fixed to the proximal end of the piston portion. The seal portion defines an annular sealing surface. An opening is defined in the housing of the electronic compressor bypass valve. The opening is defined by an annular internal surface of the housing. The method disposes the piston portion with seal portion fixed thereto in the opening in the housing of the electronic compressor bypass valve, such that upon movement of the piston portion and seal portion, the annular sealing surface slidingly engages the annular internal surface of the housing thereby creating an annular seal between the piston portion and the housing.

Other objectives, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is a partial sectional view of a conventional eCBV, having a shield pot and an O-ring for sealing between a piston and a housing, shown mounted in a bypass line.

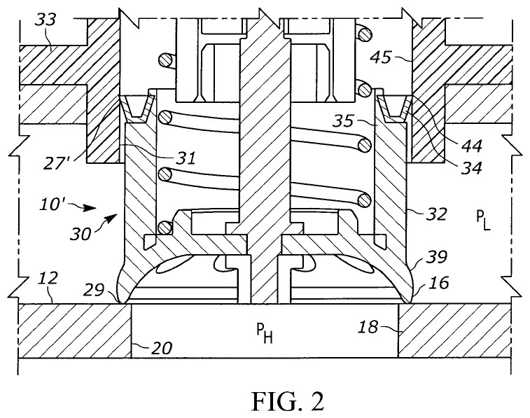

FIG. 2 is a partial sectional view of an eCBV in accordance with an embodiment, having an integrated piston-seal structure for sealing between the piston and a housing and shown mounted in a bypass line.

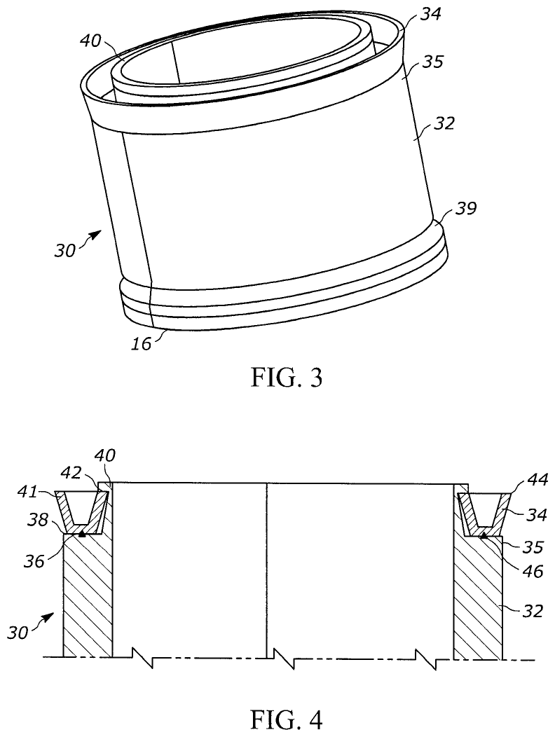

FIG. 3 is a perspective view of the integrated piston-seal structure of FIG. 2, with the seal portion having a V-shape in section.

FIG. 4 is a partial sectional view of the integrated piston-seal structure of FIG. 3.

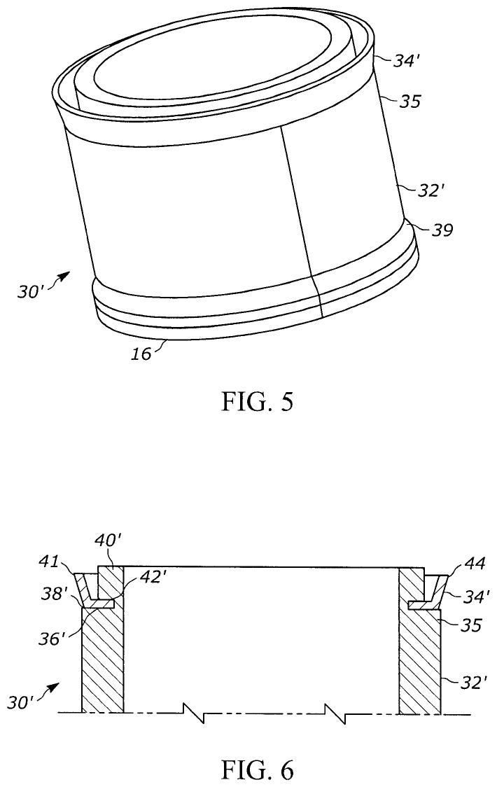

FIG. 5 is a perspective view of the integrated piston-seal structure of FIG. 2, with the seal portion having a generally half V-shape in section.

FIG. 6 is a partial sectional view of the integrated piston-seal structure of FIG. 5.

### DETAILED DESCRIPTION OF EXEMPLARY EMBODIMENTS

With reference to FIG. 2, a portion of an electronic compressor bypass valve (eCBV) is shown, generally indicated at 10′ disposed in a bypass line 12 of a turbocharger in accordance with an embodiment. The eCBV 10′ has an integrated piston-seal structure, generally indicated at 30 comprising a piston portion 32, linearly movable within an opening 31 of a housing 33 by a solenoid 25 (see FIG. 1) between open and closed positions. As best shown in FIG. 3, the piston-seal structure 30 also includes a seal portion 34 integral with a proximal end 35 the piston portion 32. In FIG. 2, the piston portion 32 is shown in closed position, with a seal surface 16 at a distal end 39 thereof engaged with the body 18 to prevent airflow between the high pressure side P_{H} and a low pressure side P_{L}, so as to prevent turbocharger surge and to reduce turbo lag.

With reference to FIGS. 3 and 4, the piston portion 32 is a generally cylindrical structure with the proximal end 35 having a first outer diameter D₁. The distal end 39 has a second outer diameter D₂. As best shown in FIG. 4, the seal portion 34 is fixed with respect to the proximal end 35 of the piston portion 32 due to a base 36 of the seal portion engaged with a shoulder 38 of the piston portion 32 and by a tab 40 of the piston portion 32 engaged with an upper surface 42 of the seal portion 34. Thus, the base 36 and upper surface 42 are in opposing relation. Alternatively, the seal portion 34 can be fixed to the proximal end 35 of the piston portion 32 by overmolding the shoulder 40 during a molding process, or can be fixed by a bond or a weld 46, or can be otherwise mechanically fastened to the piston portion 32.

In the embodiment of FIGS. 3 and 4, the seal portion 34 is annular and generally V-shaped in section, having an outwardly tapered member 41 terminating in an annular sealing surface 44. Thus, the seal portion 34 has a diameter D₂ which is larger than the first outer diameter D₁ of the proximal end 35 of the piston portion 32, such that the sealing surface 44 extends beyond the bounds of the proximal end 35 of the piston portion 32. Returning to FIG. 2, as the piston portion 32 moves along with the seal portion 34, the sealing surface 44 of the seal portion 34 slidingly engages an annular internal surface 45 of housing 33 thereby radially sealing the piston portion 32 with respect to the housing 33. The seal portion 34 is also configured to expand under pressure providing an even tighter seal. A pressure balance exists between contact areas 27′ and 29 (FIG. 2).

FIGS. 5 and 6 show another embodiment of the piston-seal structure 30′. In this embodiment, the seal portion 34′ is annular and generally of half V-shape in section and is integral with the proximal end 35 of the piston portion 32′. The seal portion 34′ is fixed with respect to the proximal end 35 of the piston portion 32′ due to a base 36′ of the seal portion 34′ engaged with a shoulder 38′ of the piston portion 32′ and by a larger tab 40′ of the piston portion 32′ engaged with an upper surface 42′ of the seal portion 34′. Thus, the base 36′ and upper surface 42′ are in opposing relation. Alternatively, the seal portion 34′ can be fixed to the proximal end of the piston portion 32′ by overmolding the shoulder 40′ during a molding process, or can be fixed by a bond or a weld 46, or can be otherwise mechanically fastened to the piston portion 32′.

Similar to the embodiment of FIGS. 3 and 4, the seal portion 34′ has an outwardly tapered member 41 terminating in the annular sealing surface 44. Thus, the seal portion 34′ has an outer diameter D₂ which is larger than the first outer diameter D₁ of the proximal end 35 of the piston portion 32′, such that the sealing surface 44 extends beyond the bounds of the piston portion 32′. As the piston portion 32′ moves along with the seal portion 34′, the sealing surface 44 of the seal portion 34′ slidingly engages the internal surface 45 of housing 33 thereby radially sealing the piston portion 32′ with respect to the housing 33. The above-mentioned pressure balance exists at the contact areas (similar to that of contact areas 27′ and 29 of FIG. 2).

With the integrated piston-seal structure 30′, the leak path of FIG. 1 between overmolding and shield pot is completely eliminated, thus the additional internal-ring 28 or laser welding process is eliminated. Also, the shield pot 26 of FIG. 1 is not needed. The seal portions 34, 34′ use less material than that of the conventional internal seal 22 of FIG. 1. Thus, the integrated piston-seal structure 30′ advantageously reduces cost, materials and assembly time, and also improves performance.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. An electronic compressor bypass valve (eCBV) comprising:
a housing having an annular internal surface defining an opening therein,
a piston-seal structure constructed and arranged to be movable linearly within the opening, the piston-seal structure comprising:
a generally cylindrical piston portion having proximal and distal ends, the distal end defining a seal surface constructed and arranged to seal with a body, the proximal end defining a first outer diameter, and
an annular seal portion fixed to the proximal end of the piston portion, the seal portion having an outer diameter that is larger than the first outer diameter of the piston portion, thereby defining an annular sealing surface,
wherein, upon movement of the piston-seal structure, the sealing surface is constructed and arranged to slidingly engage the annular internal surface of the housing thereby creating an annular seal between the piston portion and the housing.

2. The valve of claim 1, wherein the seal portion is generally V-shaped in section, having an outwardly tapered member terminating in the annular sealing surface.

3. The valve of claim 2, wherein the seal portion has a base and an upper surface in opposing relation to the base, the seal portion being fixed to the piston portion by the base being engaged with a shoulder of the piston portion and by a tab of the piston portion engaged with the upper surface of the seal portion.

4. The valve of claim 2, wherein the seal portion is fixed to the piston portion by an overmolded part of the piston portion, or by a bond or a weld.

5. The valve of claim 1, wherein the seal portion is generally of half V-shape in section, having an outwardly tapered member terminating in the annular sealing surface.

6. The valve of claim 5, wherein the seal portion has a base and an upper surface in opposing relation to the base, the seal portion being fixed to the piston portion by the base being engaged with a shoulder of the piston portion and by a tab of the piston portion engaged with the upper surface of the seal portion.

7. The valve of claim 5, wherein the seal portion is fixed to the piston portion by an overmolded part of the piston portion, or by a bond or a weld.

8. An integrated piston-seal structure for electronic compressor bypass valve, the piston-seal structure comprising:
a generally cylindrical piston portion having proximal and distal ends, the distal end defining a seal surface constructed and arranged to seal with a body, the proximal end defining a first outer diameter, and
an annular seal portion fixed to the proximal end of the piston portion, the seal portion having an outer diameter that is larger than the first outer diameter of the piston portion, thereby defining an annular sealing surface.

9. The piston-seal structure of claim 8, wherein the seal portion is generally V-shaped in section, having an outwardly tapered member terminating in the annular sealing surface.

10. The piston-seal structure of claim 8, wherein the seal portion has a base and an upper surface in opposing relation to the base, the seal portion being fixed to the piston portion by the base being engaged with a shoulder of the piston portion and by a tab of the piston portion engaged with the upper surface of the seal portion.

11. The piston-seal structure of claim 8, wherein the seal portion is fixed to the piston portion by an overmolded part of the piston portion, or by a bond or a weld.

12. The piston-seal structure of claim 8, wherein the seal portion is generally of half V-shape in section, having an outwardly tapered member terminating in the annular sealing surface.

13. The piston-seal structure of claim 12, wherein the seal portion has a base and an upper surface in opposing relation to the base, the seal portion being fixed to the piston portion by the base being engaged with a shoulder of the piston portion and by a tab of the piston portion engaged with the upper surface of the seal portion.

14. The piston-seal structure of claim 12, wherein the seal portion is fixed to the piston portion by an overmolded part of the piston portion, or by a bond or a weld.

15. A method of sealing a piston portion with respect to a housing of an electronic compressor bypass valve, the method comprising the steps of:
providing a generally cylindrical piston portion with proximal and distal ends, the distal end defining a seal surface constructed and arranged to seal with a body,
fixing an annular seal portion to the proximal end of the piston portion, the seal portion defining an annular sealing surface,
defining an opening in the housing of the electronic compressor bypass valve, the opening defined by an annular internal surface of the housing,
disposing the piston portion with seal portion fixed thereto in the opening in the housing of the electronic compressor bypass valve, such that upon movement of the piston portion and seal portion, the annular sealing surface slidingly engages the annular internal surface of the housing thereby creating an annular seal between the piston portion and the housing.

16. The method of claim 15, wherein the proximal end of the piston portion has a first outer diameter and the distal end of the piston portion has a second outer diameter, and the seal portion has an outer diameter that is larger than the first diameter of the piston portion, thereby defining the annular sealing surface, and, thereby ensuring a pressure balance between an end of the seal portion and the distal end of the piston portion.

17. The method of claim 15, wherein the seal portion is generally V-shaped or half V-shaped in section, having an outwardly tapered member terminating in the annular sealing surface.

18. The method of claim 15, wherein the fixing step includes overmolding a part of the piston portion over the seal portion or includes bonding, welding or mechanically fixing the seal portion to the piston portion.
